(19) United States
(12) Patent Application Publication
(10) Pub. No.: US 2016/0030783 A1
(43) Pub. Date: Feb. 4, 2016

(54) FACILITY FOR PRODUCING AND TREATING SMOKE

(71) Applicant: INNO2PHI, Angers (FR)

(72) Inventors: Jose COUSSEAU, LES PONTS DE CE (FR); Philippe ROUSSEAU, BEAUFORT EN VALLEE (FR)

(73) Assignee: INNO2PHI, Angers (FR)

(21) Appl. No.: 14/767,101

(22) PCT Filed: Feb. 12, 2014
(86) PCT No.: PCT/FR2014/050271

§ 371 Date: Aug. 11, 2015

(30) Foreign Application Priority Data
Feb. 12, 2013 (FR) 1351153

(51) Int. Cl. A62C 4/04; F23M 9/06; F23C 9/06; F23J 15/00

(52) U.S. Cl. CPC A62C 4/04; F23J 15/00; F23M 9/06; F23C 9/06

(57) ABSTRACT

A fume production and treatment installation includes:

a fume generator including at least one burner, a combustion chamber having at least one combustion hearth, and a fume exhaust outlet; and a confinement enclosure for confining the fumes produced by the fume generator, which enclosure has an inlet connected to the fume exhaust outlet for removing fumes from the combustion chamber, and an outlet connected to the fume generator via a fume recirculation circuit, the discharge from which into the combustion chamber being referred to as the “fume feed head”. The combustion chamber has a protective screen, interposed between the combustion hearth and the fume feed head, for protecting the feed head from the flame of the burner, the inlet for the fumes into the confinement enclosure is disposed in the upper third of the enclosure, and the confinement enclosure is equipped with a closable exhaust outlet for removing condensates.

The present invention relates to a fume production and treatment installation.

It relates more particularly to a fume production and treatment installation of the type comprising at least:
a fume generator including at least one burner, a combustion chamber having at least one combustion zone or “hearth”, in which the flame of the burner is suitable for extending, and a fume exhaust outlet for removing the fumes from said chamber; and
a confinement enclosure for confining the fumes produced by the fume generator, which enclosure has an inlet connected to the fume exhaust outlet for removing fumes from the combustion chamber, and an outlet connected to the fume generator via a fume recirculation circuit, the discharge, into the combustion chamber of the fume generator, from the recirculation circuit, being referred to as the “fume feed head”.

Such installations are well known to persons skilled in the art, as illustrated by Patent Applications FR 2 961 291, FR 2 291 454, and US 2009/0060779. However, currently, efficiency is low and fuel consumption remains high.

An object of the present invention is thus to propose an installation of the above-mentioned type that is of design making it possible to increase the efficiency and to reduce the fuel consumption of the burner.

To this end, the invention provides a fume production and treatment installation of the type comprising at least:
a fume generator including at least one burner provided with a combustion sleeve, a combustion chamber having at least one combustion zone or “hearth”, in which the flame of the burner is suitable for extending, and a fume exhaust outlet for removing the fumes from said chamber; and
a confinement enclosure for confining the fumes produced by the fume generator, which enclosure has an inlet connected to the fume exhaust outlet for removing fumes from the combustion chamber, and an outlet connected to the fume generator via a fume recirculation circuit, the discharge, into the combustion chamber of the fume generator, from the recirculation circuit, being referred to as the “fume feed head”;

said fume production and treatment installation being characterized in that said combustion chamber has a “flame-arrestor” protective screen for protecting the feed head from the flame of the burner, said protective screen for protecting the feed head from the flame of the burner being interposed between the combustion hearth and the fume feed head, in that the inlet for the fumes into the confinement enclosure is disposed in the upper third, and preferably in the upper quarter, of said enclosure, in that, above its outlet connected to the fume generator, the confinement enclosure is equipped with a closable exhaust outlet for removing condensates, which outlet is caused to be closed or opened as a function of the level of the condensates inside the enclosure, said outlet being disposed at the bottom portion of the confinement enclosure, and in that the fume feed head is made at least partially of iron, and is situated on the side of the combustion sleeve that is further from the burner.

Such an installation offers high efficiency, does not visually or physically harm the environment with emissions of fumes, and enables fuel savings to be achieved due to the chemical reactions taking place inside said installation.

The combustion sleeve, which is preferably cylindrical in shape, and which extends the burner, makes it possible to guide the flame, in particular towards the feed head. The feed head is thus situated at the free end of the combustion sleeve, preferably in alignment with said sleeve, thereby making it possible to heat the iron head. Said iron head forms an endothermic reactor that makes it possible to generate a recombination reaction of the Fischer-Tropsch type with the recirculated fumes, with the flame of the burner, and with the iron of the feed head.

In particular, the fumes are fed back by the recirculation circuit into the hottest portion of the flame of the burner, which flame is guided by the combustion sleeve. By Fischer-Tropsch effect, the unburned carbon is recombined with the hydrogen by means of the iron catalyst formed by the feed head, and then the hydrocarbon recombined in this way is burned by the flame of the burner.

In other words, the combustion sleeve is situated between the burner and the iron feed head so that the recirculated fumes are discharged in alignment with the axis of the flame, in particular in the blue portion, i.e. in the hottest portion, of the flame.

Advantageously, the volume of the confinement enclosure is not less than the volume of intake air that can be accepted by the burner for one hour.

Thus, the fumes are reinjected into the hearth of the burner, i.e. into the flame of the burner downstream from the intake of fresh air, and not into the intake of fresh air as in the solutions known from the state of the art.

By means of the solution of the invention, the fumes are charged little because the intake of fresh air is not polluted, and said little-charged fumes are re-burned in the flame of the burner. The solution of the invention thus makes it possible to obtain a reduction in fuel consumption of about 15%.

Conversely, in Document FR 2 291 454, known from the state of the art, the fumes are recirculated by being fed back into the intake of fresh air into the burner, so that the incoming air is polluted, thereby degrading the efficiency of the installation. In Document US2009/0060779 known from the state of the art, the recirculated fumes are also fed back into the fresh air of the burner, thereby causing the burner to be choked.

Preferably, the confinement enclosure has no flue that is open to the open air.

In a particular aspect of the invention, the confinement enclosure has no duct discharging into the first third of the confinement enclosure, i.e. into the zone serving to contain the condensates coming from the fumes.

Conversely, in Document FR 2 291 454, the fumes discharge into the water that is present at the bottom of the confinement enclosure, thereby polluting the water with CO₂ and with nitrogen, while, in the invention, the fumes discharge into the top of the confinement enclosure only, so that the water from the condensates is of high purity and can be used directly, e.g. for irrigation.

Preferably, the volume of the confinement enclosure is not less than the volume of air that can be accepted by the burner.

Advantageously, the confinement enclosure does not have any fume duct discharging into the first third of the confinement enclosure.

Preferably, the protective screen is made of a refractory material.

Generally, the protective screen extends inside said combustion chamber, facing the head of the burner, which head is formed by the injection zone at which a mixture of fuel and oxidizer is injected from the burner into said combustion chamber, and which corresponds to the base of the flame.

Preferably, the protective screen takes the shape of a curved plate at least partially surrounding the feed head, said feed head being in the form of a duct provided over a least a fraction of its length with a plurality of holes oriented to direct the flow of fumes towards the screen.

In particular, the plate is curved about an axis that is substantially perpendicular to the axis of the flame of the burner. Similarly, the feed head is closed at the combustion chamber of a first duct that discharges into a second duct that extends perpendicularly to the first duct, said second duct being a duct provided with holes and extending about an axis that is substantially perpendicular to the axis of the flame of the burner.

Preferably, the volume of the confinement enclosure, as expressed in cubic meters (m³) is substantially equal to the flow rate of the burner, as expressed in cubic meters per hour (m³/h). Thus, for a burner flow rate of mixture of fuel and oxidizer set at 15 m³/h, the volume of the confinement enclosure is equal to 15 m³.

Preferably, the sum of the areas of the holes in the feed head is equal to the cross-sectional area of the duct of said feed head, so as to prevent any excessive pressure.

Preferably, the feed head, disposed in the zone of thermal radiation from the screen, is spaced apart from the screen by a distance of no more than 20 centimeters (cm).

The screen is spaced apart from the injection zone of the burner by a distance of no more than 20 cm.

Generally, when the burner is in the lit state, the protective screen is spaced apart from the tip of the flame by a distance of no more than 10 cm.

In order to facilitate condensation by increasing the head-loss, the combustion chamber communicates with the inlet of the confinement enclosure via a circulation circuit including at least one baffle.

Preferably, the fume recirculation circuit extends, at least over a fraction of its length, inside the fume circulation circuit for circulating the fumes from the combustion chamber towards the confinement enclosure, in order to improve overall compactness.

Also preferably, the zone in which the recirculation circuit extends inside the circulation circuit is disposed closer to the feed head of said circuit so as to enable the recirculating fumes to be heated by coming into contact with the fumes being removed from the combustion chamber.

Preferably, the inlet of the confinement enclosure is equipped with a closure flap valve that closes said inlet when the flame of the burner is in the extinguished state, said flap valve being kept closed under the effect of its own weight. Said flap valve is suitable for going from the closed position to the open position under the effect of the pressure generated inside the fume circulation circuit by the burner.

Generally, the confinement enclosure is a semi-buried enclosure. This configuration further facilitates production of condensates.

The invention can be well understood on reading the following description of embodiments given with reference to the accompanying drawings, in which:

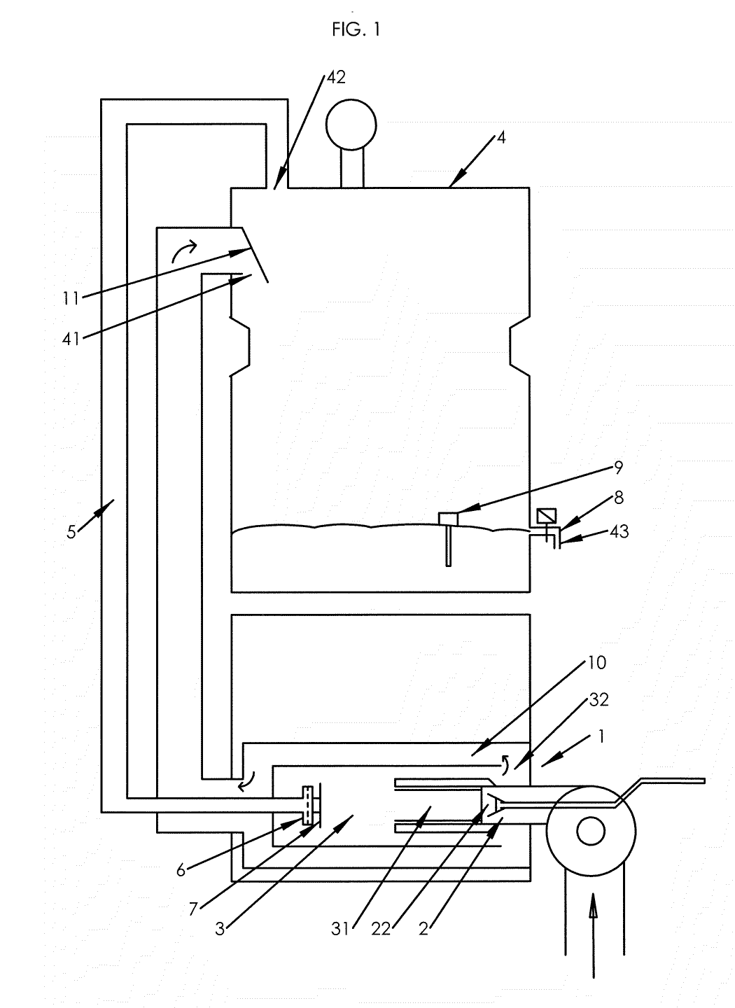

FIG. 1 is a diagrammatic view of an installation of the invention;

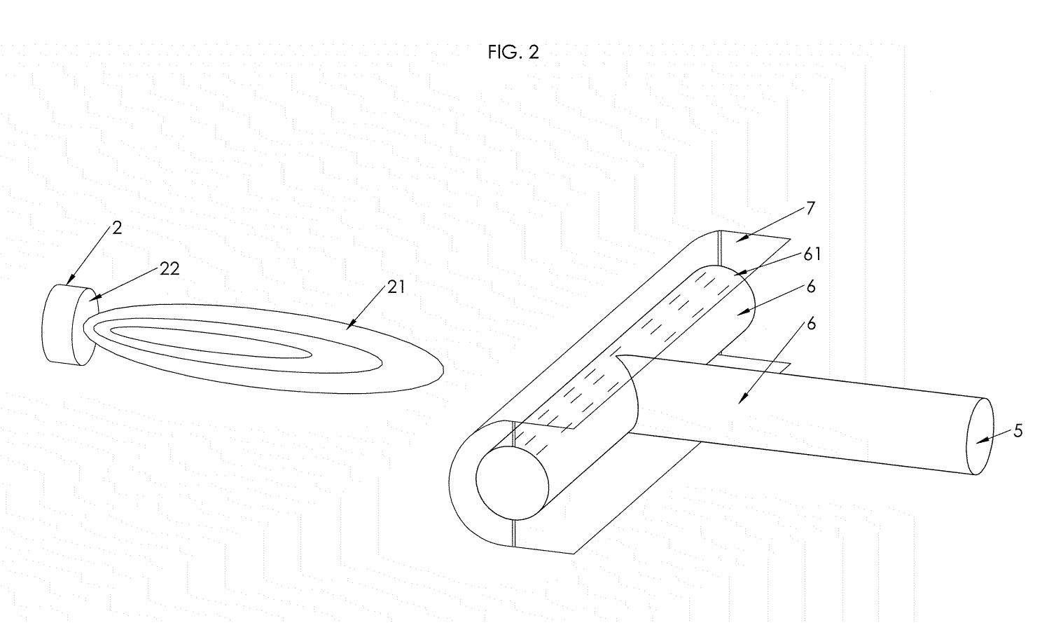

FIG. 2 is a simplified perspective view of the feed head and of the screen, which head and screen are positioned facing the flame of the burner;

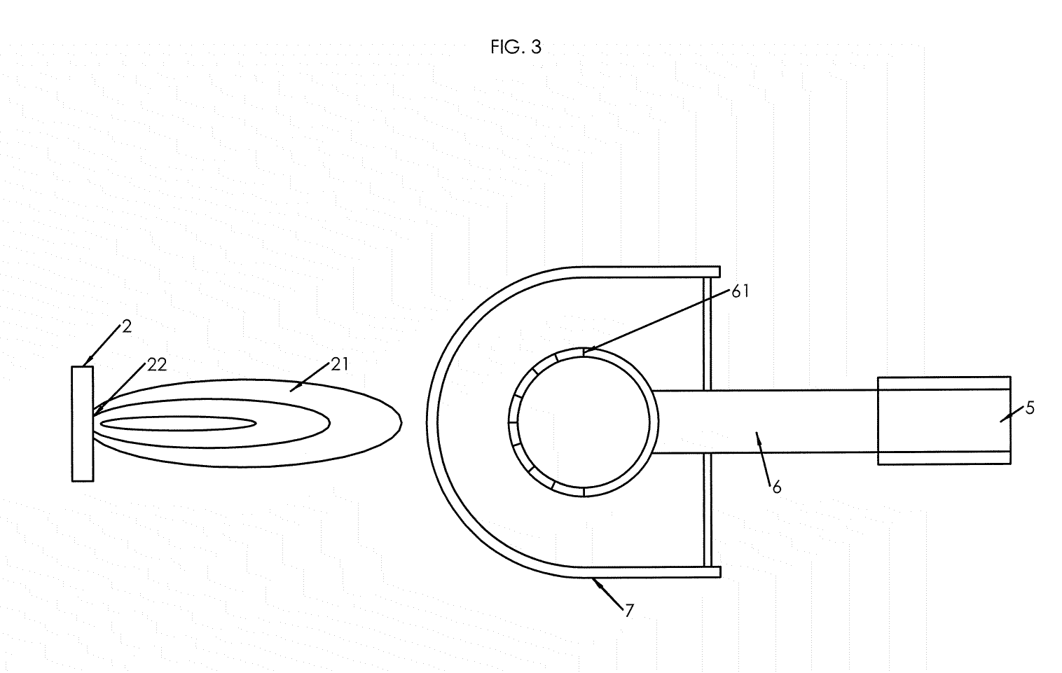

FIG. 3 is a diagrammatic section view of FIG. 2; and

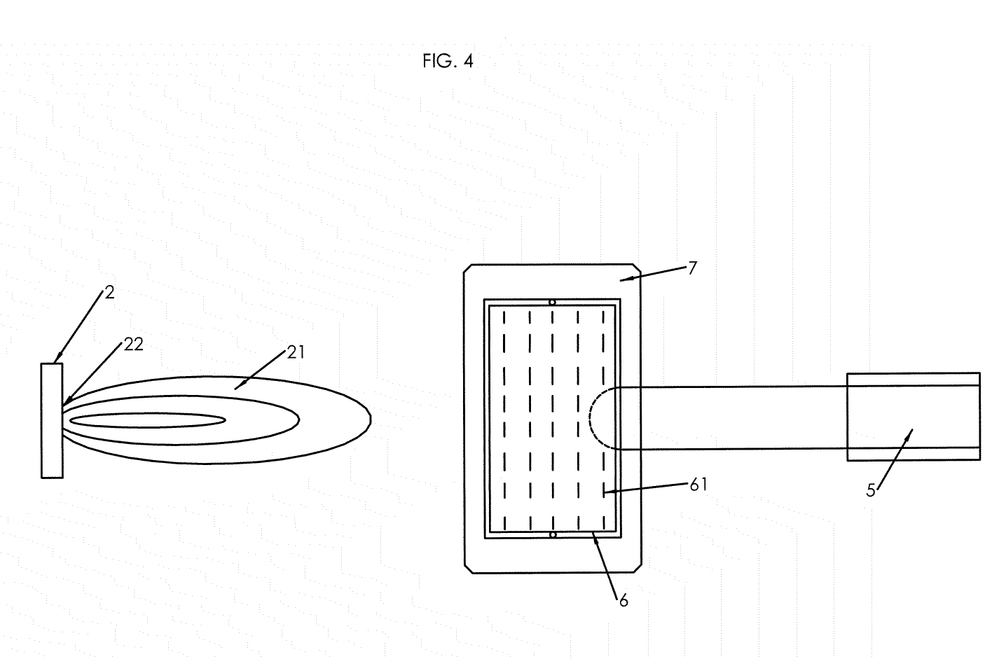

FIG. 4 is a diagrammatic plan view of the feed head and of the screen.

As mentioned above, the installation of the invention is more particularly designed to make it possible to produce fumes and to treat said fumes so as to limit emissions of said fumes into the environment with good combustion efficiency and reduced fuel consumption.

This installation thus includes a fume generator 1, such as a boiler. Said fume generator 1 includes a burner 2 suitable for mixing a fuel, such as fuel-oil, and an oxidizer, such as air, in proportions chosen as a function of the combustion to be effected.

This burner 2 is disposed at least partially inside a combustion chamber 3. In particular, the injection zone, or “head of the burner”, at which the mixture of fuel and oxidizer is injected, is disposed in a combustion chamber 3 that is also part of the fume generator 1.

The portion of the combustion chamber 3 in which the flame of the burner extends is known as the “hearth” 31 of the combustion chamber. This hearth may be formed via a pot, referred to as a “combustion pot” or as a “combustion sleeve”, and having a bottom formed by the injection head of the burner. A portion of the combustion chamber extends beyond the combustion hearth. In this example, the peripheral side wall of the combustion chamber extends around the peripheral side wall of the pot. The resulting tubular body receives the pot at one end, and is closed at its other end by a wall through which the feed head that is described below projects.

Said combustion chamber 3 is provided with a fume exhaust outlet 32 that is connected via a fume circulation circuit to a confinement enclosure 4, and in particular, to the inlet 41 of said confinement enclosure 4. Said fume exhaust outlet 32 is formed by the gap left free at one end of the tubular body of the combustion chamber between the peripheral side wall of the chamber and the peripheral side wall of the combustion pot.

Said confinement enclosure 4 has a first fume exhaust outlet 42 connected via a recirculation circuit to the end of the combustion chamber that is opposite from the end provided with the burner. It should be noted that the confinement enclosure is generally a semi-buried enclosure so as to create a temperature difference relative to the outside temperature, and so as to facilitate cooling of the fumes so that they condense.

Said confinement enclosure is equipped, at the inlet of the enclosure, with a flap valve. Said flap valve 11, which closes the inlet 41 of the confinement enclosure when the flame of the burner is in the extinguished state, is kept closed under the effect of its own weight. Said flap valve thus opens once the burner is lit.

Said confinement enclosure 4 is also provided with relief means for relieving excessive pressure inside the enclosure. These excessive pressure relief means may be formed merely by a valve.

Said confinement enclosure also has measurement means for measuring the pressure inside the enclosure so as to extinguish the burner if necessary.

Said confinement enclosure also has a condensate exhaust second outlet 43 for removing condensates from said enclosure.

The fumes inlet 41 is disposed in the upper first quarter of the confinement enclosure as shown in FIG. 1, while the condensate exhaust outlet 43 is disposed at the bottom portion of the confinement enclosure.

This condensate exhaust outlet 43 is equipped with a closure member 8, such as a solenoid valve, suitable for receiving the signals emitted by a tank-level sensor 9, as a function of the level of said tank. Via the closure member, the sensor causes the tank to open when the level of the tank is greater than a predetermined value.

The non-condensed fraction of the fumes exits from the confinement enclosure at the top portion of the enclosure via the fume exhaust outlet 42 and, via a “recirculation” circuit 5, reaches the combustion chamber 3 at a location of the chamber that is opposite from the location equipped with the burner.

The discharge from the circuit into the chamber is referred to as the “fume feed head” 6 for feeding fumes into the combustion chamber 3. This head 6 is at least partially made of iron, for the reasons explained below.

The combustion chamber 3 further includes a screen 7 that is made of a refractory material, such as a ceramic, and that separates the hearth 31 of the combustion chamber, corresponding to the location occupied by the flame of the burner, from the fume feed head 6.

In the example shown, the protective screen 7 extends facing the head 22 of the burner 2, which head is formed by the injection zone at which a mixture of fuel and oxidizer is injected from the burner 2 into said combustion chamber 3, and which corresponds to the base of the flame. In other words, when the combustion chamber 3 takes the shape of a tubular body, as in the example shown, with the injection zone of the burner disposed at one end of said body, and with the feed head disposed at the other end of the body, the screen 7 extends inside the chamber between said ends. In particular, the screen 7 extends between the fume feed head and the sleeve that extends the burner.

The protective screen 7 takes the shape of a curved plate at least partially surrounding the feed head 6, said feed head 6 being in the form of a duct provided over a least a fraction of its length with a plurality of holes 61 oriented to direct the flow of fumes towards the screen 7.

The plate is curved about an axis that is substantially perpendicular to the axis of the flame of the burner. Similarly, at least a portion of the duct of the feed head having a diffuser function extends substantially perpendicularly to the longitudinal axis of the flame.

The feed head 6, disposed in the zone of thermal radiation from the screen 7, is spaced apart from the screen by a distance of no more than 20 cm.

The screen 7 is spaced apart from the injection zone of the burner 2 by a distance of no more than 20 cm.

When the burner 2 is in the lit state, the protective screen 7 is spaced apart from the tip of the flame by a distance of no more than 10 cm.

The screen thus has a “hot” surface facing the flame of the burner and having a temperature that rises when the burner is operating, this surface being “licked” by or subject to the action of the heat given off by the flame of the burner.

Since said screen is made of a refractory material, it withstands the rise in temperature and protects the feed head that is at least partially made of iron, and that is thus more fragile. The iron is used as a catalyst.

During the combustion in the combustion chamber, said combustion produces carbon dioxide and water. A fraction of the water condenses in the confinement enclosure. The remainder of the fumes is discharged into the combustion chamber. The hydrocarbons remaining in the fumes, and in particular the carbon monoxide, recombine with the hydrogen resulting from the condensation so that, under the action of the heat produced by the screen, and in the presence of the iron of the feed head, they cause a hydrocarbon and water to be produced.

In other words, the unburned gases of the fumes and the hydrogen contained in the water vapor of the condenser formed by the confinement enclosure recombine into hydrocarbons at the feed head made of iron. Those hydrocarbons are then re-burned and, due to their presence, make it possible to reduce the quantity of fuel to be used during the combustion.

This is why such an installation makes it possible achieve lower fuel consumption and improved combustion efficiency.

1. A fume production and treatment installation of the type comprising at least:
a fume generator (1) including at least one burner (2) provided with a combustion sleeve, a combustion chamber (3) having at least one combustion zone or “hearth” (31), in which the flame (21) of the burner (2) is suitable for extending, and a fume exhaust outlet (32) for removing the fumes from said chamber (3); and
a confinement enclosure (4) for confining the fumes produced by the fume generator (1), which enclosure (4) has an inlet (41) connected to the fume exhaust outlet (32) for removing fumes from the combustion chamber (3), and an outlet (42) connected to the fume generator (1) via a fume recirculation circuit (5), the discharge, into the combustion chamber (3) of the fume generator (1), from the recirculation circuit (5), being referred to as the “fume feed head” (6);
wherein said combustion chamber (3) has a “flame-arrestor” protective screen (7) for protecting the feed head (6) from the flame (21) of the burner (2), said protective screen (7) for protecting the feed head (6) from the flame (21) of the burner (2) being interposed between the combustion hearth (31) and the fume feed head (6), the inlet (41) for the fumes into the confinement enclosure (4) is disposed in the upper third, and preferably in the upper quarter, of said enclosure (4), above its outlet (42) connected to the fume generator (1), the confinement enclosure (4) is equipped with a closable exhaust outlet (43) for removing condensates, which outlet is caused to be opened or closed as a function of the level of the condensates inside the enclosure (4), said outlet (43) being disposed at the bottom portion of the confinement enclosure (4), and the fume feed head is made at least partially of iron, and is situated on the side of the combustion sleeve that is further from the burner.

2. An installation according to claim 1, wherein the confinement enclosure (4) is not provided with a fume duct discharging into the first third of the confinement enclosure.

3. An installation according to claim 1, wherein the protective screen (7) is made of a refractory material.

4. An installation according to claim 1, wherein the protective screen (7) extends facing the head (22) of the burner (2), which head is formed by the injection zone at which a mixture of fuel and oxidizer is injected from the burner (2) into said combustion chamber (3), and which corresponds to the base of the flame.

5. An installation according to claim 1, wherein the protective screen (7) takes the shape of a curved plate at least partially surrounding the feed head (6), said feed head (6) being in the form of a duct provided over a least a fraction of its length with a plurality of holes (61) oriented to direct the flow of fumes towards the screen (7).

6. An installation according to claim 1, wherein the feed head (6) disposed in the zone of thermal radiation from the screen (7) is spaced apart from the screen by a distance of no more than 20 cm, and the plate is curved about an axis that is substantially perpendicular to the axis of the flame of the burner.

7. An installation according to claim 4, wherein the screen (7) is spaced apart from the injection zone of the burner (2) by a distance of no more than 20 cm.

8. An installation according to claim 1, wherein when the burner (2) is in the lit state, the protective screen (7) is spaced apart from the tip of the flame by a distance of no more than 10 cm.

9. An installation according to claim 1, wherein the combustion chamber (3) communicates with the inlet (41) of the confinement enclosure (4) via a circulation circuit including at least one baffle (10).

10. An installation according to claim 1, wherein the fume recirculation circuit (5) extends, at least over a fraction of its length, inside the fume circulation circuit for circulating the fumes from the combustion chamber (3) towards the confinement enclosure (4).

11. An installation according to claim 1, wherein the inlet (41) of the confinement enclosure (4) is equipped with a closure flap valve (11) that closes said inlet (41) when the flame of the burner (2) is in the extinguished state, said flap valve (11) being kept closed under the effect of its own weight.

12. An installation according to claim 1, wherein the confinement enclosure (4) is a semi-buried enclosure.

13. An installation according to claim 2, wherein the protective screen (7) is made of a refractory material.

14. An installation according to claim 2, wherein the protective screen (7) extends facing the head (22) of the burner (2), which head is formed by the injection zone at which a mixture of fuel and oxidizer is injected from the burner (2) into said combustion chamber (3), and which corresponds to the base of the flame.

15. An installation according to claim 2, wherein the protective screen (7) takes the shape of a curved plate at least partially surrounding the feed head (6), said feed head (6) being in the form of a duct provided over a least a fraction of its length with a plurality of holes (61) oriented to direct the flow of fumes towards the screen (7).

16. An installation according to claim 2, wherein the feed head (6) disposed in the zone of thermal radiation from the screen (7) is spaced apart from the screen by a distance of no more than 20 cm, and the plate is curved about an axis that is substantially perpendicular to the axis of the flame of the burner.

17. An installation according to claim 2, wherein when the burner (2) is in the lit state, the protective screen (7) is spaced apart from the tip of the flame by a distance of no more than 10 cm.

18. An installation according to claim 2, wherein the combustion chamber (3) communicates with the inlet (41) of the confinement enclosure (4) via a circulation circuit including at least one baffle (10).

19. An installation according to claim 2, wherein the fume recirculation circuit (5) extends, at least over a fraction of its length, inside the fume circulation circuit for circulating the fumes from the combustion chamber (3) towards the confinement enclosure (4).

20. An installation according to claim 2, wherein the inlet (41) of the confinement enclosure (4) is equipped with a closure flap valve (11) that closes said inlet (41) when the flame of the burner (2) is in the extinguished state, said flap valve (11) being kept closed under the effect of its own weight.
